(19) United States
(12) Patent Application Publication
(10) Pub. No.: US 2012/0234497 A1
(43) Pub. Date: Sep. 20, 2012

(54) DEBONDER TO MANUFACTURE SEMICONDUCTOR AND DEBONDING METHOD THEREOF

(75) Inventors: Il Young Han, Uiwang-si (KR); Ho Geon Song, Suwon-si (KR); Sang Wook Park, Hwaseong-si (KR); Ji-Seok Hong, Seoul (KR)

(73) Assignee: Samsung Electronics Co., Ltd, Suwon-si (KR)

(21) Appl. No.: 13/418,795

(22) Filed: Mar. 13, 2012

(30) Foreign Application Priority Data
Mar. 14, 2011 (KR) 10-2011-0022201

(51) Int. Cl. B32B 38/10

(52) U.S. Cl. 156/701; 156/750

(57) ABSTRACT

A debonder to manufacture a semiconductor that includes: a stage to support a carrier wafer that is attached to a chip stack assembly by a temporary adhesive layer coated on the surface of the carrier wafer; a chuck arranged above the stage to selectively secure the chip stack assembly; a lifting unit to lift the chuck from the stage; a lateral driving unit to move the chuck laterally with respect to the stage; and a controller to control the lifting unit and the lateral driving unit.

### CROSS-REFERENCE TO RELATED APPLICATION

This application claims the benefit of Korean Patent Application No. 10-2011-0022201, filed on Mar. 14, 2011, in the Korean Intellectual Property Office, the disclosure of which is incorporated herein in its entirety by reference.

### BACKGROUND

1. Field of the Invention

The present inventive concept relates to a debonder to manufacture a semiconductor and a debonding method thereof.

2. Description of the Related Art

As electronic products have become more compact and multifunctional, semiconductor devices used therein have become highly integrated and multifunctional. To cope with the demand for such products, a multichip package (MCP) semiconductor device to package a plurality of chips in a single semiconductor device has been suggested.

A MCP semiconductor device may include a monolayer MCP semiconductor device and a multilayer MCP semiconductor device. A monolayer MCP semiconductor device includes a package having a plurality of chips arranged in parallel to each other. A multichip MCP semiconductor device may be referred to as a stack-type semiconductor device and includes a package having a plurality of chips stacked in layers.

A stack-type semiconductor device has a 3 dimensional structure. A conventional stack-type semiconductor device is configured to communicate various signals by connecting input/output terminals of the stacked chips, or by connecting input/output terminals of each chip and external connection terminals of the stack-type semiconductor device, through wire bonding.

However, wiring bonding increases inductance, so that the performance of a semiconductor device is reduced and the size of a semiconductor device is increased. To address these drawbacks, wafer socket probe (WSP) technology has been developed.

According to the WSP technology, a via hole is formed to vertically penetrate a plurality of chips using a laser at a wafer level. The via hole is filled by a through-silicon-via (TSV) to directly connect circuits of each of the stacked chips. Thus, in a stack-type semiconductor device adopting the WSP technology, since the stacked chips are directly connected, wires are unnecessary. As a result, the performance of a semiconductor device may be improved. Also, since a vertical interval between the chips is decreased, the thickness of a stack-type semiconductor device may be remarkably reduced. Furthermore, a mounting area of a semiconductor device may also be reduced.

A temporary adhesive debonding process (hereinafter referred to as a debonding process) is needed to fill the via hole with the TSV. A temporary adhesive is coated on a carrier wafer or glass, chips are stacked thereon, and many processes are then performed to thereby make a chip stack assembly. Thereafter, according to the debonding process, the carrier wafer and the chip stack assembly are separated from each other so that a stack-type semiconductor device is manufactured.

Methods of debonding include a laser irradiation method, a UV irradiation method, and a thermal sliding method. In the thermal sliding method, heat is applied to a temporary adhesive layer between the carrier wafer and the chip stack assembly so that the carrier wafer and the chip stack assembly may be separated from each other by sliding the carrier wafer.

However, since the chip stack assembly is restricted due to adhesive viscosity around an edge of the carrier wafer, the chip stack assembly may be debonded only by applying a large shear force. Since the carrier wafer is not uniformly level due to having steps, a bump formed in the chip stack assembly, in particular, at the lowest position thereof, may be damaged by the carrier wafer during sliding. As the shear force is increased, the possibility of the bump being damaged increases. Therefore, an improved structure to reduce a shear force during the debonding process is needed.

### SUMMARY

The inventive concept provides a debonder to manufacture a semiconductor that reduces a shear force applied during a debonding process, so that damage to a bump of a chip may be reduced, and a debonding method thereof.

Additional features and advantages of the present general inventive concept will be set forth in part in the description which follows and, in part, will be obvious from the description, or may be learned by practice of the general inventive concept.

According to various embodiments of the inventive concept, there is provided a debonder to manufacture a semiconductor, which includes: a stage to support a carrier wafer that is attached to a chip stack assembly by a temporary adhesive layer coated on the surface of the carrier wafer; a chuck arranged above the stage to be selectively attached to the chip stack assembly; a lifting unit to move the chuck up and down; a lateral driving unit connected to move the chuck laterally with respect to the carrier wafer; and a controller to control the operation the lifting unit and the lateral driving unit.

The debonder may further include a rotation unit to rotate the carrier wafer relative to the chip stack assembly.

The rotation unit may be a rotation motor that is directly connected to the stage.

The controller may control the rotation unit to rotate the stage so that the carrier wafer rotates with respect to the chip stack assembly.

The controller may control the lifting unit to lift the chip stack assembly from the carrier wafer and may control the lateral driving unit and the rotation unit to rotate the chip stack assembly relative to the carrier wafer while simultaneously moving the carrier wafer relative to the chip stack assembly in a lateral direction.

The lifting unit may further include a load cell that measures a load when the chuck lifts the chip stack assembly.

At least one of the lifting unit and the lateral driving unit may include a servo motor that moves the respective unit in a linear direction.

The chuck may be any one selected from an electrostatic chuck, an adhesive chuck, and a vacuum chuck.

A heater may be provided in the chuck, and the controller may control the heater to heat the temporary adhesive layer when the chuck lifts the chip stack assembly.

A cooling line may be further provided in the stage.

According to various embodiments of the inventive concept, there is provided a debonding method to manufacture a semiconductor, the method including lifting a chip stack assembly from a carrier wafer adhered to the chip stack assembly using a temporary adhesive layer with respect to the carrier wafer, and debonding the chip stack assembly from the carrier wafer by sliding the chip stack assembly with respect to the carrier wafer.

The debonding method may further include rotating the carrier wafer relative to the chip stack assembly.

According to some embodiments, the carrier wafer may be rotated.

According to various embodiments, the carrier wafer may be rotated relative to the chip stack assembly while the chip stack assembly is moved laterally with respect to the carrier wafer.

The debonding method may further include heating the temporary adhesive layer, before the lifting of the chip stack assembly.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 schematically illustrates a debonder to manufacture a semiconductor, according to an exemplary embodiment of the present inventive concept;

FIG. 2 is a block diagram of the debonder of FIG. 1;

FIG. 3 is a flowchart explaining a debonding method to manufacture a semiconductor, according to an exemplary embodiment of the present inventive concept;

FIGS. 4A, 4B, and 4C illustrate position changes of a temporary adhesive layer, according to rotation and sliding operations of a chuck during a debonding process, according to an exemplary embodiment of the present inventive concept;

FIGS. 5-9 illustrate a debonding process using the debonder of FIG. 1; and

FIG. 10 schematically illustrates a debonder to manufacture a semiconductor, according to another exemplary embodiment of the present inventive concept.

### DETAILED DESCRIPTION OF THE EXEMPLARY EMBODIMENTS

The attached drawings for illustrating embodiments of the inventive concept are referred to in order to gain a sufficient understanding of the inventive concept and the merits thereof. Hereinafter, the inventive concept will be described in detail by explaining embodiments of the inventive concept with reference to the attached drawings. Like reference numerals in the drawings denote like elements.

Reference will now be made in detail to the exemplary embodiments of the present general inventive concept, examples of which are illustrated in the accompanying drawings, wherein like reference numerals refer to the like elements throughout. The exemplary embodiments are described below, in order to explain the present general inventive concept while referring to the figures.

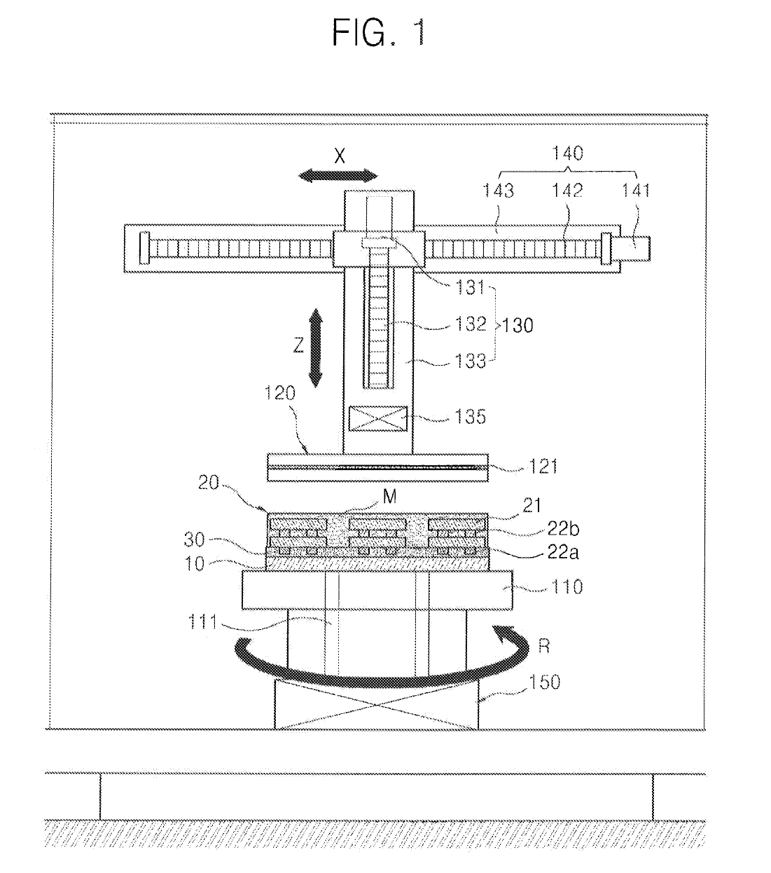

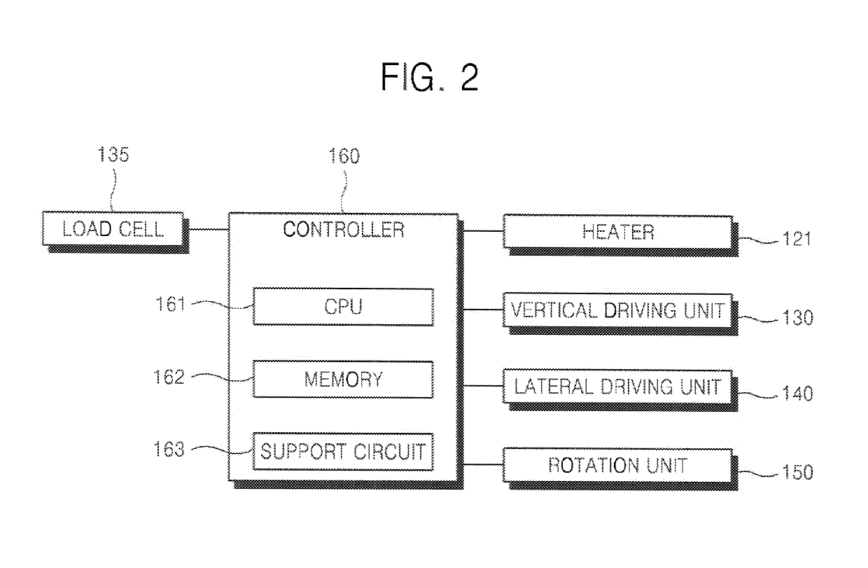

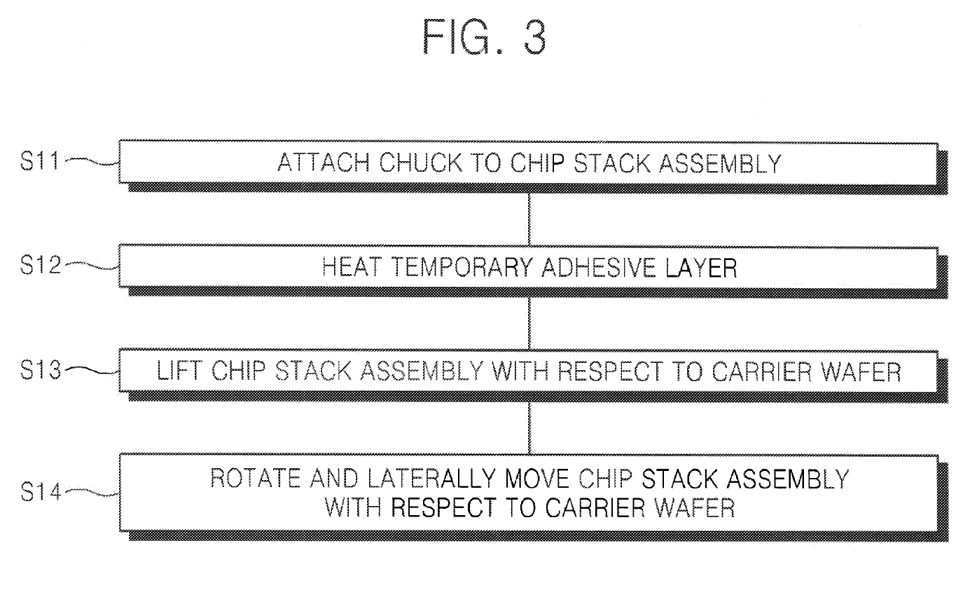

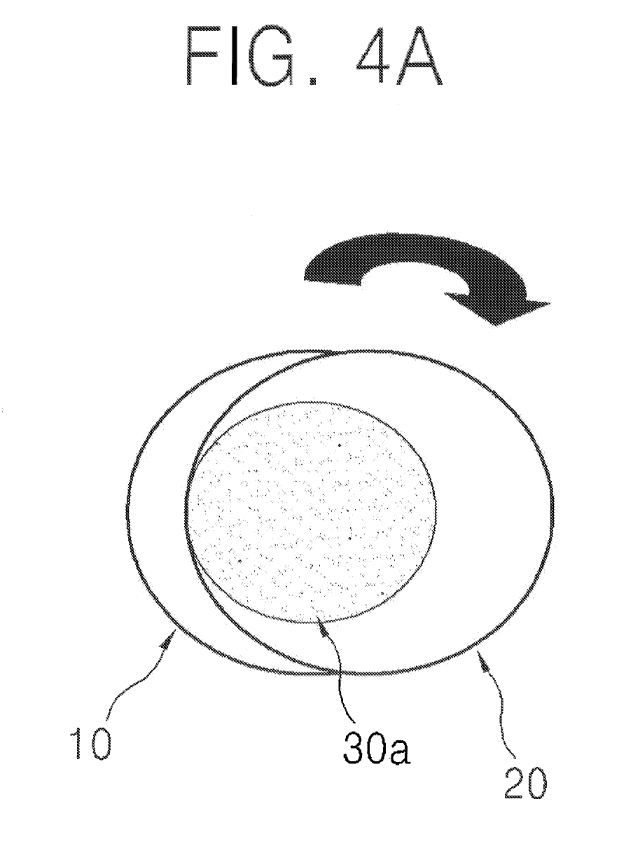

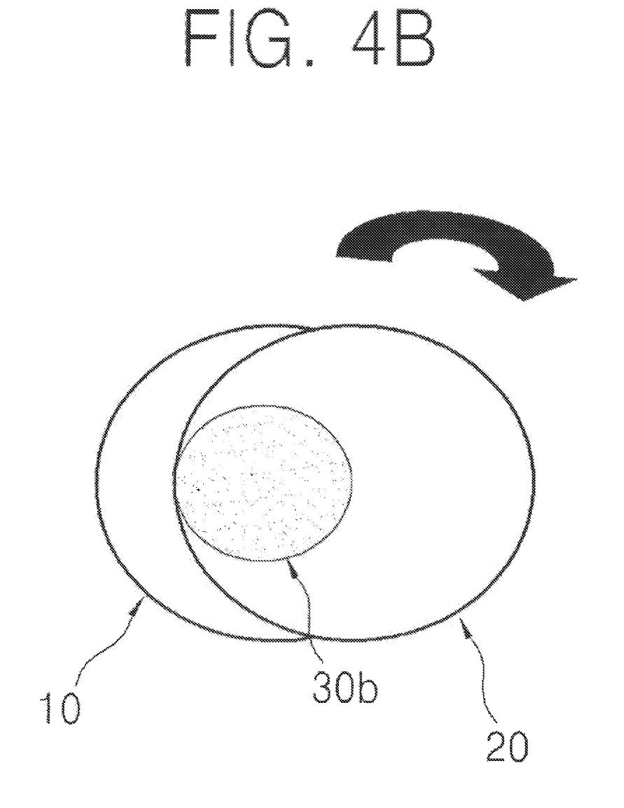

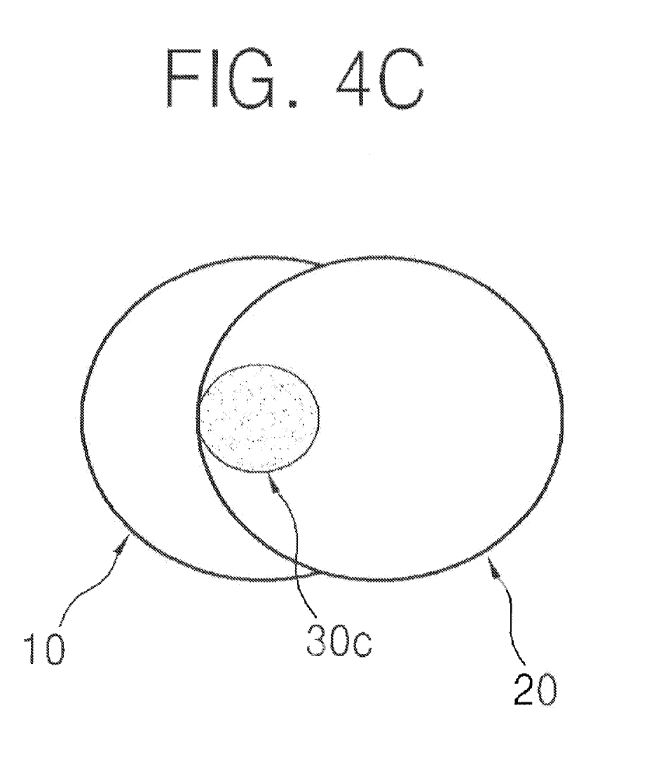

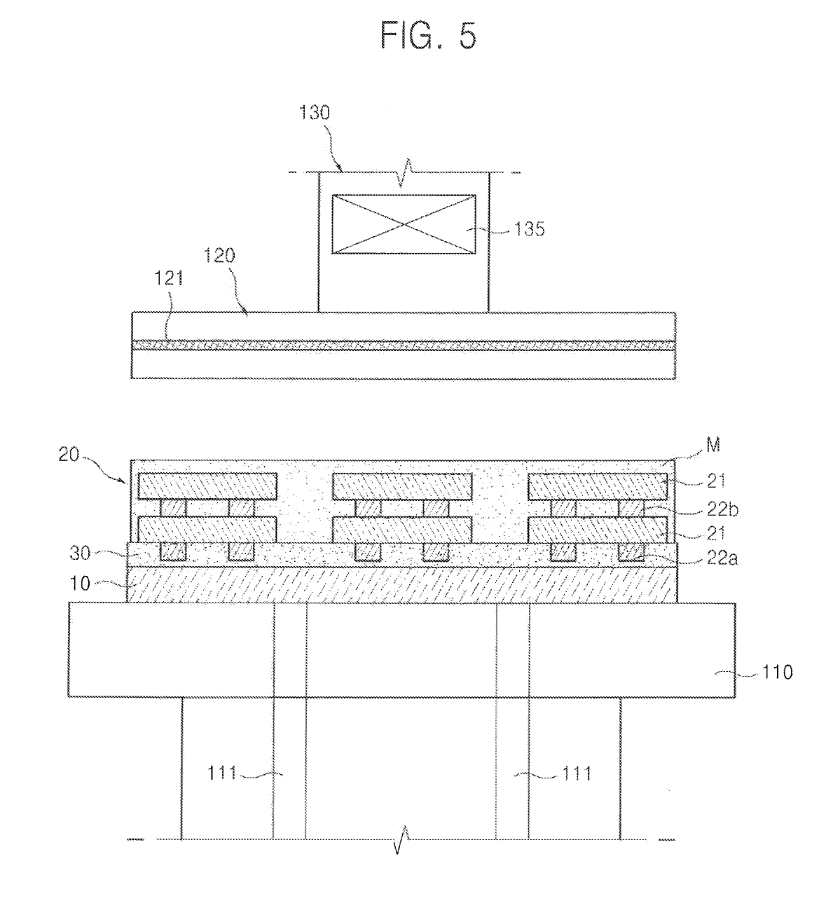

FIG. 1 schematically illustrates a debonder to manufacture a semiconductor, according to an exemplary embodiment of the present inventive concept. FIG. 2 is a block diagram of the debonder of FIG. 1. FIG. 3 is a flowchart explaining a debonding method to manufacture a semiconductor, according to an exemplary embodiment of the present inventive concept. FIGS. 4A, 4B, and 4C illustrate position changes of a temporary adhesive layer, according to rotation and sliding operations of a chuck during a debonding process. FIGS. 5-9 illustrate step by step a debonding process using the debonder of FIG. 1.

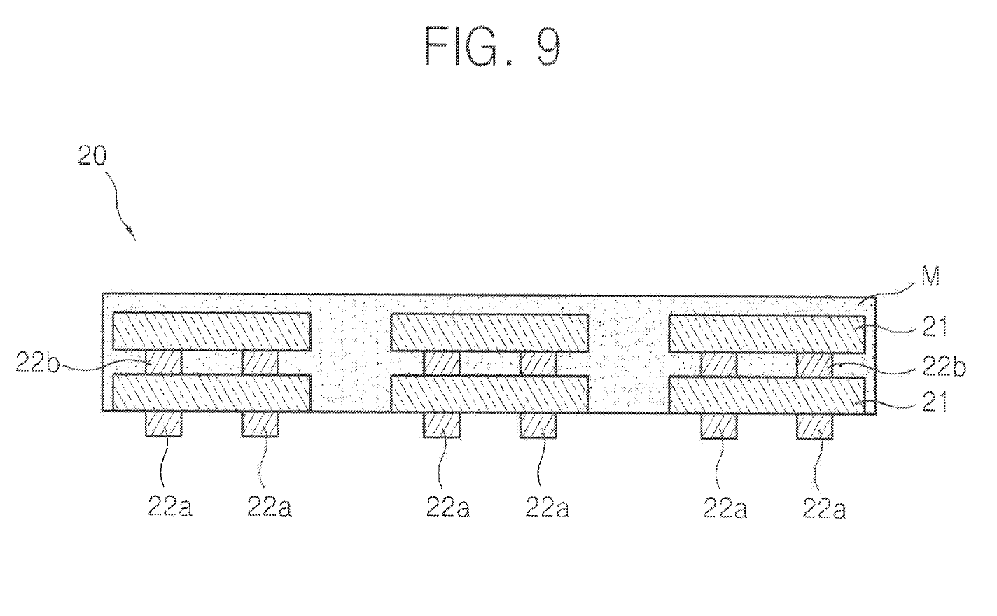

Referring to FIGS. 1-9, in order to separate, that is, debond, a chip stack assembly 20 configured as illustrated in FIG. 9, for example, with respect to a carrier wafer 10 forming a support surface, the debonder according to the present exemplary embodiment includes a stage 110 to support a carrier wafer 10, a chuck 120 to selectively attach to the chip stack assembly 20, a lifting unit 130 to move the chuck 120 up or down in a Z direction of FIG. 1, a lateral driving unit 140 to move the chuck 120 in an X direction of FIG. 1, a rotation unit 150 to rotate the stage 110 in an R direction of FIG. 1, a controller 160 (see FIG. 2) to control the above elements, and a cabinet 170 to house the above elements.

The carrier wafer 10 forms a support surface to support the chip stack assembly 20. The chip stack assembly 20 includes chips 21 that are connected by bumps 22a and 22b. In the present exemplary embodiment, although the carrier wafer 10 is described, the present inventive concept is not limited thereto. For example, a carrier glass may be used in place of the carrier wafer 10.

During manufacturing, a temporary adhesive layer 30 is coated on the carrier wafer 10, and the chips 21 are stacked thereon in a vertical direction. The chips 21 may be wafers. Next, a via hole that vertically penetrates the chips 21 is formed using a laser, at a wafer level. The via hole is filled with a through silicon via (TSV), which directly connects circuits of each of the chips 21. Finally, the chips 21 are molding (M) processed, to complete the chip stack assembly 20.

The stage 110 initially supports the carrier wafer 10, as illustrated in FIGS. 1 and 5-8. Although it is not illustrated, a vacuum hole to stably apply suction to the carrier wafer 10 may be provided on a surface of the stage 110. A cooling line 111 is provided in the stage 110. After the debonding process is completed, the cooling line 111 supplies a coolant to lower the temperature of the stage 10 after a heating process is performed using a heater 121. The coolant may be a liquid or a gas.

The chuck 120 is configured to be attached to the chip stack assembly 20. The chuck 120 may be selected from an electrostatic chuck (ES-chuck), an adhesive chuck, and a vacuum chuck. However, any suitable type of chuck may be used.

For reference, an electrostatic chuck is described below. The electrostatic chuck may be a uni-polar chuck, a bi-polar chuck, or a tri-polar chuck.

In a uni-polar chuck, a (+) voltage is applied to the chuck, and the chuck is grounded by the generation of plasma. To detach the chuck, a reverse bias is applied to the chuck. If a reverse bias is not applied to the chuck, a uni-polar chuck tends to remain attached to the chip stack assembly 20 for several to tens of minutes, even when power supply is discontinued.

In a bi-polar chuck, +/− DC voltages are applied to the chuck, and the chuck is detached by applying a reverse bias to the voltage applied to the chuck. Since a bi-polar chuck operates according to the voltage change, plasma generation is not necessary.

A tri-polar chuck, which is otherwise similar to the bi-polar chuck, differs in that a DC self-bias generated in plasma is read to compensate for the +/− voltages by Vdc, so that a net charge between the chip stack assembly 20 and the electrostatic chuck may be zero.

If the chuck 120 is an electrostatic chuck, the chuck 120 may be uni-polar, bi-polar, of tri-polar. If the chuck is 120 bi-polar, since the chuck 120 may remain attached to the chip stack assembly 20 for some time after a voltage is cut off, the chip stack assembly 20 may be prevented from falling off of the chuck 120, due to external factors such as a power failure. Thus, the chip stack assembly 20 may be protected from damage.

The heater 121 is provided in the chuck 120. The heater 121 is connected to the controller 160. The controller 160 may control of the operation of the heater 121, so as to heat the temporary adhesive layer 30 when the chuck 120 is attached to the chip stack assembly 20. When the heater 121 is turned to heat the temporary adhesive layer 30, the temporary adhesive layer 30 may assume a gel state. In other words, the adhesiveness/viscosity of the temporary adhesive layer 30 may be reduced by the heating.

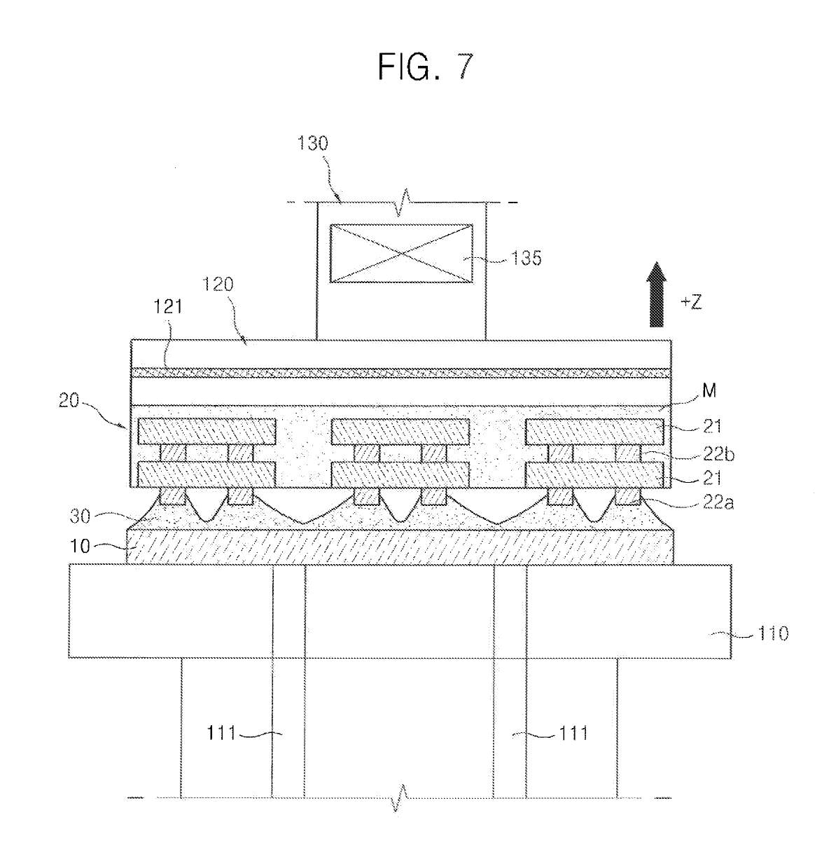

The lifting unit 130 is connected to the chuck 120 and drives the chuck 120 in the Z direction of FIG. 1. That is, the lifting unit 130 is driven to move the chuck 120 such that the chuck 120 lifts the chip stack assembly 20 in order to create a gap between the carrier wafer 10 and the bumps 22a of the chip stack assembly 20, as illustrated in FIG. 7. The temporary adhesive layer 30 is heated so as to have a low enough viscosity for the lifting unit 130 to lift the chip stack assembly 20 from the stage 110.

The lifting unit 130 includes a load cell 135 to measure a load applied to the chuck 120 when lifting the chip stack assembly 20. The load cell 135 outputs the load measurement to the controller 160. The load cell 135 can detect a failure of the debonding process, by detecting whether the load level exceeds a first load level or is less than a second load level.

The distance the chuck 120 is raised is exaggerated in FIG. 7 for convenience of explanation and is actually very small in comparison. The lifting unit 130 may be controlled by the controller 160.

Referring to FIG. 1, the lifting unit 130 includes a first servo motor 131, a first ball screw 132 connected to a motor shaft of the first servo motor 131, and driving the chuck 120 to move in the Z direction when rotated by the first servo motor 131. The driving unit 130 also includes a driving frame 133 to house the above elements.

When the first servo motor 131 is operated in a forward direction, the chuck 120 may move upward, according to the operation of the first ball crew 132. When the first servo motor 131 is operated in a backward direction, the chuck 120 may move downward, according to the operation of the first ball crew 132. The debonding process may be performed through the above operations.

Since the lifting unit 130 lifts the chip stack assembly 20 during the debonding process, even if a step exists due to a surface irregularity of the carrier wafer 10, the lowermost bumps 22a do not contact the carrier wafer 10 during a subsequent sliding operation. As a result, damage to the bumps 22a is prevented.

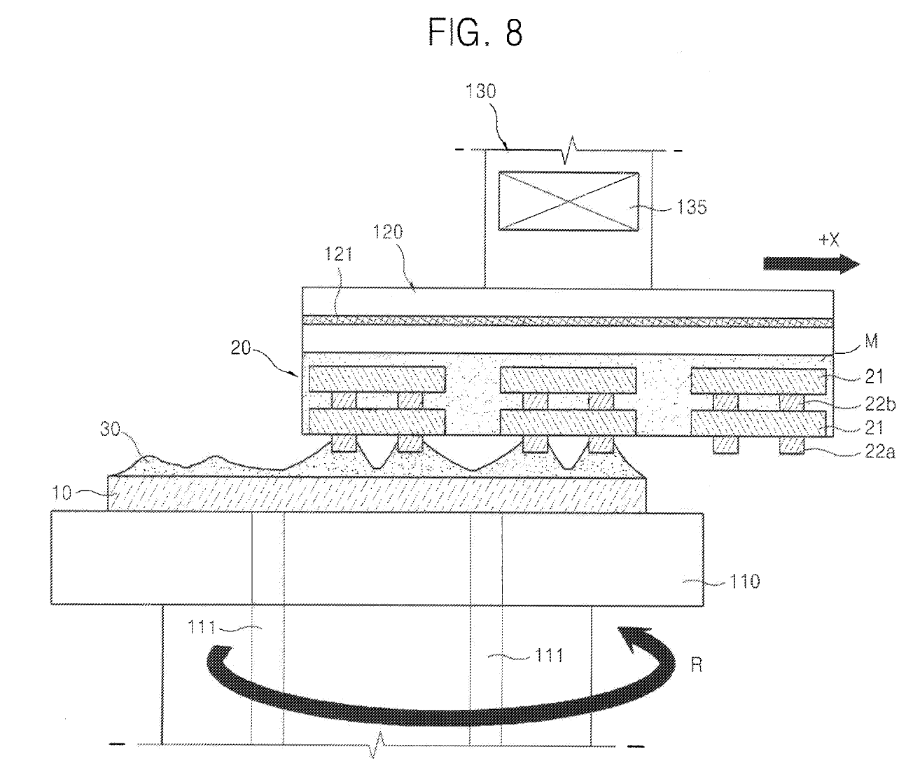

The lateral driving unit 140 is connected to the chuck 120 and moves the chuck 120 laterally in the X direction of FIG. 1. That is, the lateral driving unit 140 moves stack assembly 20 along the +X axis with respect to the carrier wafer 10, as illustrated in FIG. 8. The lateral driving unit 140 is driven together with the rotation unit 150, as described below. The lateral driving unit 140 may be controlled by the controller 160 to move linearly.

Referring back to FIG. 1, the lateral driving unit 140 includes a second servo motor 141 and a second ball screw 142 connected to a motor shaft of the second servo motor 141 that moves the chuck 120 in the X direction of FIG. 1, while being rotated in forward and backward directions by the second servo motor 141. The lateral driving unit 140 also includes a lateral driving frame 143 to house the above elements.

When the second servo motor 141 is operated in the forward direction, the chuck 120 may be moved in the +X direction, according to the rotation of the second ball screw 142. When the second servo motor 141 is operated in the backward direction, the chuck 120 may be moved in the −X direction, according to the rotation of the second ball crew 142. The debonding process may be performed through the above operations.

The rotation unit 150 rotates the stage 110 in the R direction of FIG. 1. In the present exemplary embodiment, the rotation unit 150 is embodied by a rotational motor that is directly coupled to the stage 110. However, the rotation unit 150 may be a servo motor according to some aspects of the present disclosure.

The rotation unit 150 rotates the carrier wafer 10 in the R direction of FIG. 8, with respect to the chip stack assembly 20, when the chip stack assembly 20 is debonded. The carrier wafer may be rotated by less than 360 degrees. For example, the carrier wafer 10 may be rotated in the R direction in a range of several to tens of degrees.

FIGS. 4A, 4B, 4C, and 8 illustrate the operations of the lateral driving unit 140 and the rotation unit 150. Referring to FIGS. 4A, 4B, and 4C, the left circles relate to the carrier wafer 10, the right circles relate to the chip stack assembly 20, and the dotted center circles relate to temporary adhesive layers 30a, 30b, and 30c.

Referring to FIG. 7, debonding is performed by lifting the chip stack assembly 20 from the carrier wafer 10, and then using the lateral driving unit 140 to move the chip stack assembly 20 in one direction, without the operation of the rotation unit 150. In this case, the rotation unit 150 may not be operated, since the area of the temporary adhesive layer 30a is rather large, as illustrated in FIG. 4A. Thus, the debonding of the chip stack assembly 20 may be impeded by the large area of the temporary adhesive layer 30a.

When the lateral driving unit 140 slides the chip stack assembly 20 after the chip stack assembly 20 is lifted, a shear force needed for the debonding process may be reduced. However, the bumps 22a may still be damaged by the temporary adhesive layer 30.

However, in the present exemplary embodiment of FIG. 8, after the chip stack assembly 20 is lifted, the rotation unit 150 rotates the carrier wafer 10 in the R direction, while the lateral driving unit 140 slides the chip stack assembly 20 in the +X direction. Since the rotation and lateral operations are simultaneously performed, the areas of the temporary adhesive layers 30a, 30b, and 30c are gradually reduced, as shown in FIGS. 4A to 4C, thereby debonding the chip stack assembly 20.

In other words, when the rotation and sliding operations are simultaneously performed after the chip stack assembly 20 is lifted, a shear force during the debonding process may be remarkably reduced. As such, the bumps 22a may be protected from damage.

When the rotation and lateral operations are simultaneously performed as in the present exemplary embodiment, a cross point between the carrier wafer 10 and the chip stack assembly 20 is generated. The cross point forms an edge seed that facilitates the separation of the carrier wafer 10 and the chip stack assembly 20. Accordingly, as illustrated in FIGS. 4A, 4B, and 4C, the areas of the temporary adhesive layers 30a, 30b, and 30c are gradually decreased. As a result, the shear force needed for debonding may be reduced, as compared to the related art. Thus, damage to the bumps 22a may be reduced.

In the present exemplary embodiment, although the rotation motor directly connected to the stage 110 to rotate the carrier wafer 10, the rotation unit 150 may be applied to rotate the chuck 120. Since the above structure may be simply embodied by coupling a rotation motor (not shown) to the chuck 120, an illustration thereof is omitted.

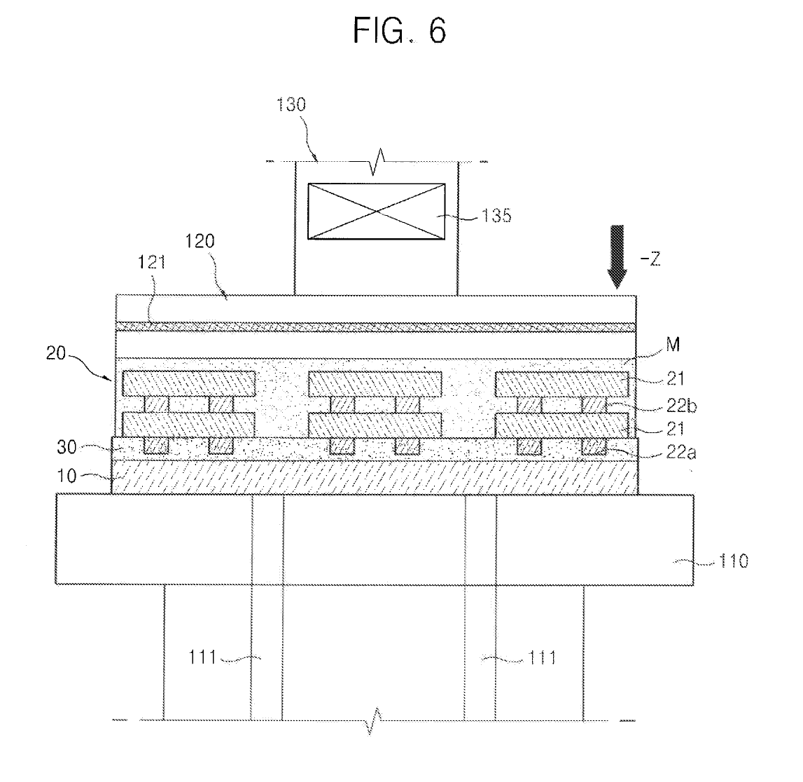

The controller 160 controls the operations of the heater 121, the lifting unit 130, the lateral driving unit 140, and the rotation unit 150, so as to debond the chip stack assembly 20 from the carrier wafer 10, as illustrated in FIGS. 2, 8, and 9. That is, the controller 160 turns on the heater 121 when the chuck 120 is attached to the chip stack assembly 20 as illustrated in FIG. 6, operates the lifting unit 130 to lift the chuck 120 as illustrated in FIG. 7, and then operates the rotation unit 150 to rotate the carrier wafer 10. Simultaneously, the controller 160 operates the lateral driving unit 140 so that the chip stack assembly 20 may be debonded from the carrier wafer 10 while moving laterally with respect to the carrier wafer 10.

The controller 160 includes a central processing unit (CPU) 161, a memory 162, and a support circuit 163, as illustrated in FIG. 2. The CPU 161 may be any suitable type of computer processor that can control the debonding process. The memory 162 is connected to the CPU 161. The memory 162 is a computer readable recording medium and may be installed locally or remotely. For example, the memory 162 may be a random access memory (RAM), a read only memory (ROM), a floppy disk, a hard disk, or any suitable digital storage device. The support circuit 163 is coupled to the CPU 161 and supports operations of a processor. The support circuit 163 may include a cache, a power supply, a clock circuit, an input/output circuit, and a subsystem, for example.

For example, the processes to control the operations of the heater 121, the chuck 120, the lifting unit 130, the rotation unit 150, and the lateral driving unit 140, so that the chip stack assembly 20 may be debonded from the carrier wafer 10, may be stored in the memory 162. Typically, a software routine to perform such control operations may be stored in the memory 162. The software routine may be stored or executed by another CPU (not shown).

Although the processes of the present inventive concept are executed by a software routine, at least a part of the processes of the present inventive concept may be executed by hardware. The processes of the present inventive concept may be embodied by software executed on a computer system, hardware such as an integrated circuit, or a combination of software and hardware.

A debonding method to manufacture a semiconductor having the above structure according to the present exemplary embodiment will be described below with reference to FIGS. 3 and 5-9. Referring to FIG. 5, the carrier wafer 10 is initially supported on the stage 110. The temporary adhesive layer 30 is disposed on an upper surface of the carrier wafer 10. The chip stack assembly 20 is fabricated while attached to the temporary adhesive layer 30, with the temporary adhesive layer 30 being in a solidified state.

In this state, the lifting unit 130 moves the chuck 120 in the −Z direction, so that the chuck 120 may be attached to the chip stack assembly 20 (S11). As described above, the chuck 120 may be any one selected from the electrostatic chuck, the adhesive chuck, and the vacuum chuck.

As shown in FIG. 6, the controller 160 turns on the heater 121 to heat the temporary adhesive layer 30 (S12). When the temporary adhesive layer 30 is heated, the temporary adhesive layer 30 assumes a gel-like state.

Next, as illustrated in FIG. 7, the controller 160 controls the lifting unit 130 to lift the chuck 120 in the +Z direction. At this time, the chip stack assembly 20 is lifted such that the temporary adhesive layer 30 is elastically deformed (S13).

Then, as illustrated in FIG. 8, the controller 160 controls the rotation unit 150 to rotate the carrier wafer 10 in the R direction and simultaneously controls the lateral driving unit 140 to move the chip stack assembly 20 in the +X direction. In other words, the chip stack assembly 20 is rotated in the R direction and simultaneously moved in the +X direction, with respect to the carrier wafer 10 disposed thereunder (S14). Accordingly, as described above with reference to FIG. 4, the adhesion of the temporary adhesive layers 30a, 30b, and 30c is gradually decreased so that the chip stack assembly 20 may be easily debonded from the carrier wafer 10 with a relatively low amount of shear force.

When the lateral driving unit 140 moves the chip stack assembly 20 completely off of the stage 110, the chip stack assembly 20 is debonded as illustrated in FIG. 9. Then the completed chip stack assembly 20 may be input to another process.

According to the above-described structure and operation according to the present exemplary embodiment, the shear force needed for a debonding process may be remarkably reduced so that damage to a bump of a chip may be reduced.

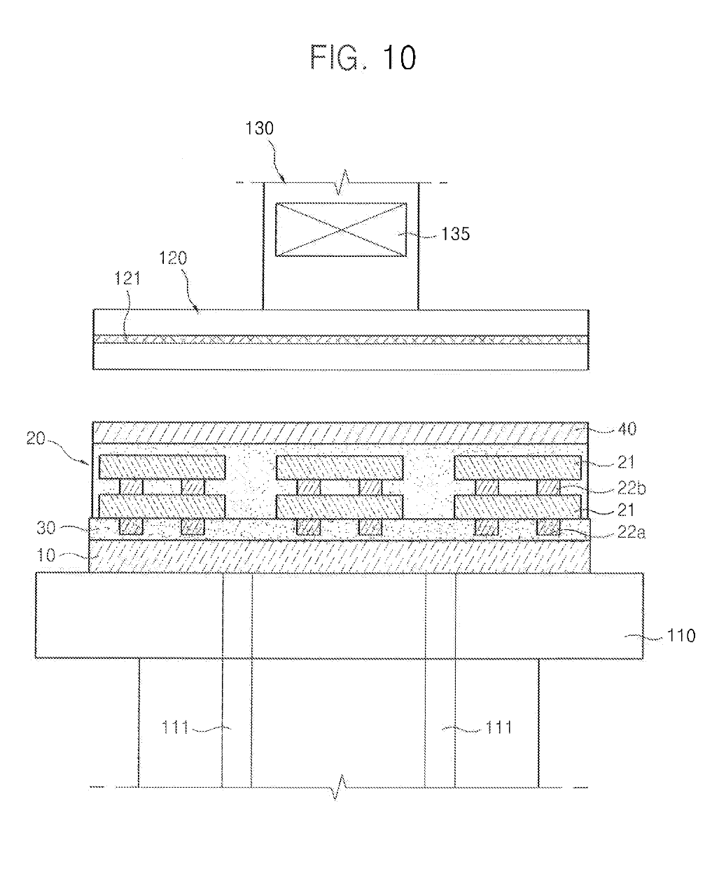

FIG. 10 schematically illustrates a debonder to manufacture a semiconductor according to another exemplary embodiment of the present inventive concept. In the above-described exemplary embodiment, the chuck 120 directly attaches to the upper surface of the chip stack assembly 20, and the heater 121 radiates heat toward the chip stack assembly 20.

However, when a wafer heating stage 40 is separately provided on an upper surface of the chip stack assembly 20, the wafer heating stage 40 and the stage 10 are heated together, so as to heat the temporary adhesive layer 30. In this case, a heater may be provided at the stage 10, and thus, a heating time may be reduced. The subsequent lifting, rotation, and sliding operations are similar to those described above.

As described above, according to the present inventive concept, the shear force applied during a debonding process may be remarkably reduced, so that damage to bumps of a chip may be reduced.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A debonder to manufacture a chip stack assembly, the debonder comprising:
a stage to support a carrier wafer upon which the chip stack assembly is disposed;
a temporary adhesive layer to adhere the chip stack assembly to the carrier wafer;
a chuck to selectively attach to the chip stack assembly;
a lifting unit to lift the chuck from the stage;
a lateral driving unit to move the chuck laterally with respect to the stage; and
a controller to control the lifting unit and the lateral driving unit to lift the chip stack assembly from the carrier wafer and move the chip stack assembly laterally with respect to the carrier wafer.

2. The debonder of claim 1, further comprising a rotation unit to rotate one of the chuck and the stage relative to the other.

3. The debonder of claim 2, wherein the rotation unit comprises a rotation motor directly connected to the stage.

4. The debonder of claim 3, wherein the rotation unit rotates the carrier wafer.

5. The debonder of claim 4, wherein the controller is configured to control the lifting unit, the lateral driving unit, and the rotation unit to lift the chip stack assembly up from the carrier wafer, and then rotate the carrier wafer with respect to the chip stack assembly while simultaneously moving the carrier wafer laterally with respect to the chip stack assembly.

6. The debonder of claim 1, wherein the lifting unit further comprises a load cell to measure a load applied to the chuck when the chuck lifts the chip stack assembly.

7. The debonder of claim 1, wherein at least one of the lifting unit and the lateral driving unit comprises a servo motor controlled by the controller.

8. The debonder of claim 1, wherein the chuck is any one selected from an electrostatic chuck, an adhesive chuck, and a vacuum chuck.

9. The debonder of claim 8, wherein the chuck comprises a heater to heat the temporary adhesive layer.

10. The debonder of claim 1, wherein the stage comprises a cooling line.

11. A method to debond a chip stack assembly adhered to a carrier wafer by a temporary adhesive, the method comprising:
lifting the carrier wafer from the carrier wafer; and
debonding the chip stack assembly from the carrier wafer by moving the chip stack assembly laterally with respect to the carrier wafer.

12. The method of claim 11, further comprising rotating the carrier wafer relative to the chip stack assembly.

13. The method of claim 12, wherein the carrier wafer is rotated.

14. The method of claim 13, wherein the rotation of the carrier wafer and movement of the chip stack assembly occur substantially simultaneously.

15. The method of claim 11, further comprising heating the temporary adhesive layer before lifting the chip stack assembly.

16. A debonder to debond a chip stack assembly, the debonder comprising:
a stage to support a carrier wafer upon which the chip stack assembly is adhered by a temporary adhesive;
a chuck to selectively attach to the chip stack assembly;
a lifting unit to lift the chuck with respect to the stage;
a lateral driving unit to laterally move the chuck with respect to the stage; and
a rotation unit to rotate the chip stack assembly relative to the carrier wafer.

17. The debonder of claim 16, further comprising a controller to control the lifting unit to lift the chip stack assembly from the carrier wafer, and to control the lateral driving unit and the rotation unit to move the chip stack assembly laterally with respect to the carrier wafer while rotating one of the chuck and the stage relative to the other.

18. The debonder of claim 16, further comprising a heater to heat the adhesive layer.

19. The debonder of claim 16, wherein the lifting unit lifts the chuck such that the chip stack assembly is separated from the stage and the temporary adhesive layer contacts the stage and the chip stack assembly.
